(19) United States
(12) Patent Application Publication
(10) Pub. No.: US 2020/0021324 A1
(43) Pub. Date: Jan. 16, 2020

(54) SHELL FOR AT LEAST ONE ELECTRONIC DEVICE AND METHOD FOR MANUFACTURING THE SAME

(71) Applicants: SHENZHEN FUTAIHONG PRECISION INDUSTRY CO., LTD., Shenzhen (CN); FIH (HONG KONG) LIMITED, Kowloon (HK)

(72) Inventors: CHWAN-HWA CHIANG, New Taipei (TW); CHEN-YI TAI, New Taipei (TW); ZENG-MAO ZHENG, Shenzhen (CN)

(21) Appl. No.: 16/236,447

(22) Filed: Dec. 29, 2018

(30) Foreign Application Priority Data
Jul. 11, 2018 (CN) 201810757689.0

(51) Int. Cl. H04B 1/3888; B21D 5/16

(52) U.S. Cl. CPC H04B 1/3888; B21D 5/16

(57) ABSTRACT

A shell for at least one electronic device which is very resilient for everyday purposes and which in addition can restore itself after severe deformations by being heated includes at least one frame, the frame being made in one or more parts out of memory metal. The disclosure also provides a method for manufacturing the shell.

### FIELD

The subject matter disclosed herein generally relates to a shell for at least one electronic device and method for manufacturing the same.

### BACKGROUND

A shell of an electronic device is mostly made of metal or plastic. The shell can be easily deformed, its appearance may be affected after being handled for a long period of time, and if the device is dropped.

Therefore, there is room for improvement in the art.

### BRIEF DESCRIPTION OF THE DRAWINGS

Implementations of the present disclosure will now be described, by way of embodiments only, with reference to the attached figures.

FIG. 1 is a perspective view showing a first embodiment of a shell for at least one electronic device according to the present disclosure.

FIG. 2 is a perspective view showing a second embodiment of the shell for at least one electronic device according to the present disclosure.

FIG. 3 is a perspective view showing a third embodiment of the shell for at least one electronic device according to the present disclosure.

FIG. 4 is a flowchart for manufacturing the shell for at least one electronic device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain portions may be exaggerated to better illustrate details and features of the present disclosure.

The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean “at least one.”

The term “comprising,” when utilized, means “including, but not necessarily limited to”; it specifically indicates open-ended inclusion or membership in the so-described combination, group, series, and the like.

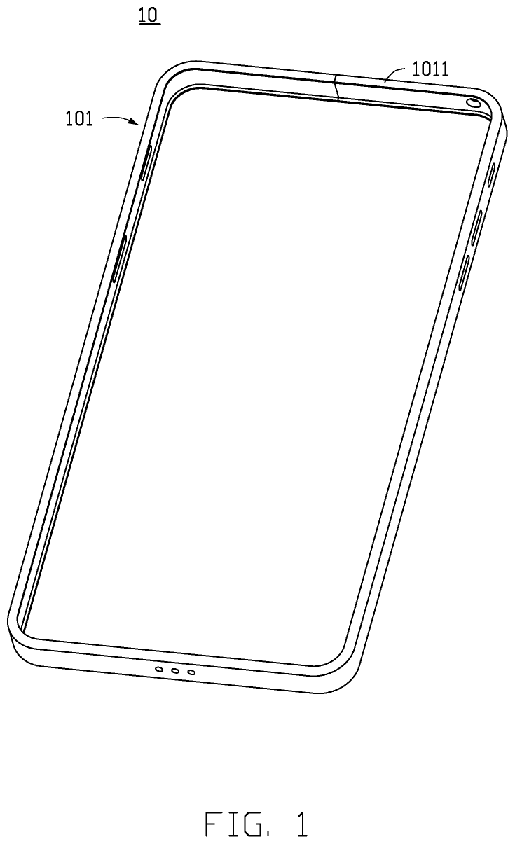

FIGS. 1-3 show a shell 10. The shell 10 may be a shell for an electronic device, such as a mobile phone, a tablet, or a smart watch. In at least one embodiment, the shell 10 is a shell for a mobile phone.

In FIG. 1, the shell 10 includes at least one frame 101. The frame 101 has a thickness ranging from 0.8 millimeter to 1.2 millimeters.

The shell 10 may further includes buttons, cameras, and other electronic components not shown in the FIG. 1.

The shell 10 is made of a memory metal. The memory metal restores to its original shape after being deformed by pressure or impact. So, the shell 10 can restore to its original shape by being heated after being deformed.

Furthermore, the shell 10 does not need to be heated if the external force is small and in a range of self-restoring force.

Furthermore, the memory metal being hyperelastic, the shell 10 has a high degree of resilience when squeezed or dropped.

The memory metal may be nickel-titanium-based memory alloy, copper-based shape memory metal alloy, iron-based shape memory metal alloy, or gold-cadmium alloy.

The nickel-titanium based memory alloy may be titanium-nickel alloy, nickel-titanium-niobium alloy, or titanium-nickel-palladium alloy.

The copper-based shape memory metal alloy may be copper-gold-tin alloy, copper-aluminum alloy, or copper-tin alloy.

The iron-based shape memory metal alloy may be iron-palladium alloy or iron-manganese-silicon alloy.

In at least one embodiment, the frame 101 is formed from a single metal strip 1011 which is bent into a rectangle shape. Two ends of the metal strip 1011 can be joined together by one of riveting, nanometer injection molding, die casting, welding, and on the like, to obtain a closed frame 101.

In other embodiments, a shape of the frame 101 is not limited to being rectangular, it can be various other shapes according to the actual needs of the user.

In other embodiments, the frame 101 can be made from two or three or four metal strips 1011 joined together to form a closed frame 101.

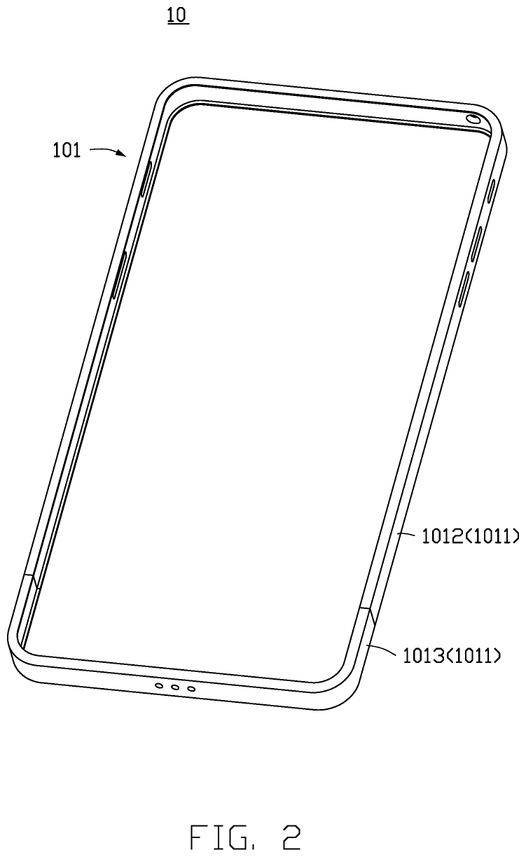

As in FIG. 2, the frame 101 is formed by two metal strips 1011. The two metal strips 1011 are bent to form a first portion 1012 and a second portion 1013. The first portion 1012 and the second portion 1013 are both U-shaped. The first portion 1012 and the second portion 1013 are located opposite to each other and joined together to form the frame 101, and further form the shell 10. In at least one embodiment, the frame 101 is made of titanium-nickel alloy.

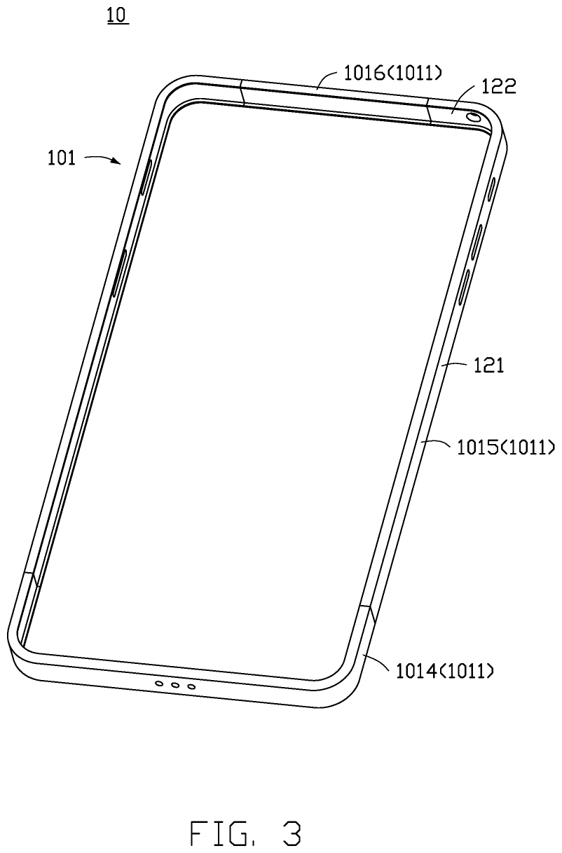

Referring to FIG. 3, the frame 101 is formed by four metal strips 1011. Three of the four metal strips 1011 are bent to form a first side portion 1014 and two second side portions 1015. The remaining metal strip 1011 is not bent and forms a third side portion 1016 of the frame 101. The first side portion 1014 is U-shaped. The two second side portions 1015 are L-shaped. Each of the two second side portions 1015 includes a longer side wall 121 and a shorter side wall 122 connected to the longer side wall 121. Two ends of the first side portion 1014 are respectively joined to two ends of the long side walls 121. Two ends of the third side portion 1016 are respectively joined to two ends of the short side walls 122.

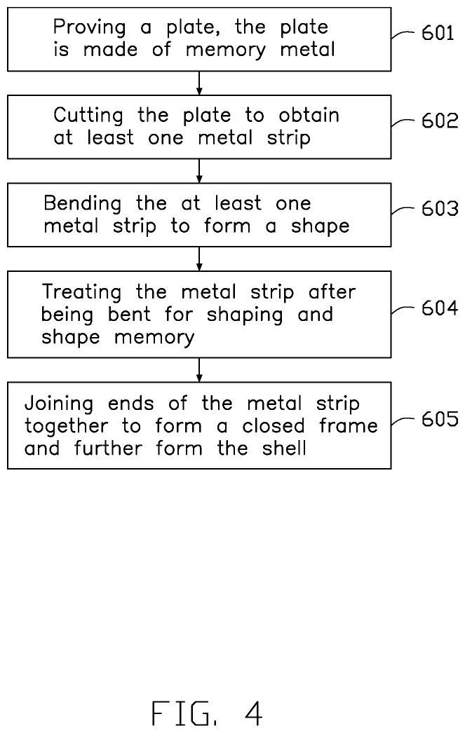

FIG. 4 illustrates a flowchart of a method for manufacturing the shell 10. The method is provided by way of example, as there are a variety of ways to carry out the method. The method described below can be carried out using the configurations illustrated in FIG. 4, for example, and various elements of these figures are referenced in explaining example method. Each block shown in FIG. 4 represents one or more processes, methods, or subroutines, carried out in the exemplary method. Furthermore, the illustrated order of blocks is by example only and the order of the blocks can change. Additional blocks may be added or fewer blocks may be utilized, without departing from this disclosure. The exemplary method can begin at block 601.

At block 601, a plate is provided, the plate is made of memory metal.

The memory metal may be nickel-titanium based memory alloy, copper-based shape memory metal alloy, iron-based shape memory metal alloy, or gold-cadmium alloy. The nickel-titanium based memory alloy may be titanium-nickel alloy, nickel-titanium-niobium alloy, or titanium-nickel-palladium alloy. The copper-based shape memory metal alloy may be copper-gold-tin alloy, copper-aluminum alloy, or copper-tin alloy. The iron-based shape memory metal alloy may be iron-palladium alloy or iron-manganese-silicon alloy.

At block 602, the plate is cut to obtain at least one metal strip 1011.

In at least one embodiment, there is one metal strip 1011.

In other embodiments, there may be two, three, or four metal strips 1011.

At block 603, the at least one metal strip 1011 is bent to form various shapes, such as rectangular, oval, or trapezoidal shape.

At block 604, the metal strip 1011 after being bent is treated for shaping and shape memory to give a memory to the metal strip 1011.

In at least one embodiment, the metal strip 1011 after being bent is put into a shaping mold (not shown in FIGS. 1-4) for shaping treatment and shape memory treatment. A treatment temperature of the shaping treatment and shape memory treatment is from about 500 degrees Celsius to 800 degrees Celsius. A treatment time of the shaping treatment and shape memory treatment is about 1 hour.

The shell 10 can be heated to restore to its original shape after being deformed. The higher the treatment temperature, the higher is the restoration heating temperature.

At block 605, two ends of the metal strip 1011 are joined together to form a closed frame 101 and further form the shell 10.

The two ends of the metal strip 1011 can be joined together by riveting, nanometer injection molding, die casting, or welding, to obtain the frame 101.

In at least one embodiment, the two ends of the metal strip 1011 are joined together by nanometer injection molding.

The frame 101 has a thickness ranging from 0.8 millimeter to 1.2 millimeters.

In at least one embodiment, the frame 101 is rectangular.

With the above configuration, the frame 101 of the shell 10 is made of memory metal, so the shell 10 has a memory function. That is, the shell 10 can be heated to restore to its original shape after deformation. The memory metal being hyperelastic, the shell 10 is very resilient against everyday impact and mishandling in any event.

The embodiments shown and described above are only examples. Many details are often found in the art such as the other features of a shell for at least one electronic device. Therefore, many such details are neither shown nor described. Even though numerous characteristics and advantages of the present disclosure have been positioned forth in the foregoing description, together with details of the structure and function of the present disclosure, the disclosure is illustrative only, and changes can be made in the detail, including in matters of shape, size, and arrangement of the parts within the principles of the present disclosure, up to and including the full extent established by the broad general meaning of the terms used in the claims. It will therefore be appreciated that the embodiments described above can be modified within the scope of the claims.

What is claimed is:

1. A shell for at least one electronic device, comprising:
at least one frame, wherein the frame is made of a memory metal.

2. The shell of claim 1, wherein the memory metal is nickel-titanium based memory alloy, copper-based shape memory metal alloy, iron-based shape memory metal alloy, or gold-cadmium alloy.

3. The shell of claim 2, wherein the nickel-titanium based memory alloy is titanium-nickel alloy, nickel-titanium-niobium alloy, or titanium-nickel-palladium alloy.

4. The shell of claim 2, wherein the copper-based shape memory metal alloy is copper-gold-tin alloy, copper-aluminum alloy, or copper-tin alloy.

5. The shell of claim 2, wherein the iron-based shape memory metal alloy is iron-palladium alloy or iron-manganese-silicon alloy.

6. The shell of claim 2, wherein the frame has a thickness ranging from 0.8 millimeter to 1.2 millimeters.

7. The shell of claim 1, wherein the frame comprises a metal strip, the metal strip is bent to form a shape, two ends of the metal strip are joined together to form a close frame.

8. The shell of claim 1, wherein the frame comprises two metal strips, the two metal strips are bent respectively to form a first portion and a second portion, the first portion and the second portion are both U-shaped, the first portion and the second portion are opposite to each other and joined to each other to form the frame.

9. The shell of claim 1, wherein the frame comprises four metal strips, three of the four metal strips are bent respectively to form a first side portion and two second side portions, the remaining one of the four metal strips forms a third side portion, the first side portion is U-shaped, the two second side portions are each L-shaped, each of the two second side portions comprises a longer side wall and a shorter side wall connected to the longer side wall, two ends of the first side portion are respectively joined to two ends of the longer side walls, two ends of the third side portion are respectively joined to two ends of the shorter side walls.

10. A method for manufacturing a shell for at least one electronic device, comprises:
providing a plate, the plate being made of memory metal;
cutting the plate to obtain at least one metal strip;
bending the at least one metal strip to form a shape;
treating the metal strip after being bent for shaping and shape memory; and
joining ends of the metal strip together to form a closed frame and to further form the shell.

11. The method of claim 10, wherein the memory metal is nickel-titanium based memory alloy, copper-based shape memory metal alloy, iron-based shape memory metal alloy, or gold-cadmium alloy.

12. The method of claim 11, wherein the nickel-titanium based memory alloy is titanium-nickel alloy, nickel-titanium-niobium alloy, or titanium-nickel-palladium alloy.

13. The method of claim 11, wherein the copper-based shape memory metal alloy is copper-gold-tin alloy, copper-aluminum alloy, or copper-tin alloy.

14. The method of claim 11, wherein the iron-based shape memory metal alloy is iron-palladium alloy or iron-manganese-silicon alloy.

15. The method of claim 11, wherein the metal strip after being bent is put into a shaping mold for shaping treatment and shape memory treatment.

16. The method of claim 15, wherein a treatment temperature of the shaping treatment and shape memory treatment is from 500 degrees Celsius to 800 degrees Celsius.

17. The method of claim 15, wherein a treatment time of the shaping treatment and shape memory treatment is about 1 hour.

18. The method of claim 11, wherein the two ends of the metal strip is joined together by riveting, nanometer injection molding, die casting, welding or the like, to obtain the frame.
